(19) United States
(12) Patent Application Publication
(10) Pub. No.: US 2009/0157879 A1
(43) Pub. Date: Jun. 18, 2009

(54) SYSTEM AND METHOD FOR PROVIDING WEB SERVICES WITH LOAD BALANCING

(76) Inventor: Philip Stoll, Ann Arbor, MI (US)

Correspondence Address: UNISYS CORPORATION, UNISYS WAY, MAIL STATION: E8-114, BLUE BELL, PA, 19424, US

(21) Appl. No.: 12/238,499

(22) Filed: Sep. 26, 2008

Related U.S. Application Data
(60) Provisional application No. 60/995,630, filed on Sep. 27, 2007.

(51) Int. Cl. G06F 15/173

(52) U.S. Cl. 709/226

(57) ABSTRACT

A method, apparatus, and article of manufacture web services provides web services with load balancing of image processing in a document processing environment. A Load Balancing Web Service hosted on a network connected server receives web services processing requests from application programs using a web services interface. The load balancing web service forwards these processing requests to data processing web services running on a plurality of web servers using a priority scheme that attempts to assign requests based upon differences in the processing time needed by these servers to process pending requests, and based on round robin cycling when there are no differences in the processing time needed by these servers to process requests. The load balancing web service receives responses from the data processing web services running on a plurality of web servers and forwards the responses to the application programs.

### RELATED CASES

This application claims the benefit of U.S. Provisional Patent Application entitled, “System and Method for providing Web Services with Load Balancing,” Ser. No. 60/995,630, Attorney Docket No. PM124.P, filed Sep. 27, 2007.

### TECHNICAL FIELD

This application relates in general to a method, apparatus, and article of manufacture for providing distributed computer data processing, and more particularly to a method, apparatus, and article of manufacture for providing web services for image processing in a document processing environment.

### BACKGROUND

Distributed processing has begun to utilize processing architectures that include processing services typically referred to as “web services” in which a request for processing is transmitted from an application program to a web services server through a loosely coupled, and discoverable interface. The web service returns results to the requested processing that the application program may use in further processing. These architectures allow for services to be provided to a large number of possible requesting application programs as needed while permitting the resources of these servers to be shared efficiently.

In order for the web services to operate, application programs are required to know or discover at runtime the identity of the web service servers that may provide the desired processing services. Typically, application programs have been simple in that they direct all request for services to a single server. Such arrangements have not been easily scalable as the number of processing requests grows. Web servers may be limited in the number of simultaneous processing requests that may be supported. When the resources of a single server are insufficient to support the pending processing requests, additional servers may need to be utilized. However, the identity of such an additional server needs to be communicated to the application programs in order for the additional requests to be sent to the additional servers. In addition, the processing requirements may vary significantly over time, and as such, the number of servers and their respective identities must also be maintained and provided to the application programs.

Finally, the application programs may be numerous and hosted in a large number of processing systems attached to a communications network. If the communications network included the Internet, modifying the all of application programs to support changes in the operation of the web services is costly. As such, a need to provide a scalable mechanism for providing web services that accounts for changing processing loads in a dynamic and simple way is needed. The present invention attempts to address these deficiencies in the prior art systems.

### SUMMARY OF THE INVENTION

In accordance with the present invention, the above and other problems are solved by providing a method, apparatus, and article of manufacture for providing web services for image processing in a document processing environment.

The great utility of the invention is that this system is designed to provide a mechanism to perform load balancing among a plurality of web service processing servers to provide improved processing throughput and scalability of web services for application programs. A Load Balancing Web Service hosted on a network connected server receives web services processing requests from application programs using a web services interface. The load balancing web service forwards these processing requests to data processing web services running on a plurality of web servers using a priority scheme that attempts to assign requests based upon the processing time needed by these servers to process pending requests. The load balancing web service receives responses from the data processing web services running on a plurality of web servers and forwards the responses to the application programs.

One aspect of the present invention includes a method for providing web services for image processing in a document processing environment. The method receives a web service request message from an application program, maintains a count of pending web service requests for each of a plurality of web services providing data processing services to the application program, selects one of the plurality of web services using the count of pending web service requests for each of the plurality of web services, and forwards the web service message to one of the plurality of web services to obtain data processing services for the application program.

Another aspect of the present invention includes a distributed processing system for providing image processing in a document processing environment. The system includes an application program, a load balancing web service, and a plurality of web services providing data processing services to the application program. The load balancing web service receives a web service request message from the application program, maintains a count of pending web service requests for each of a plurality of web services providing data processing services to the application program, selects one of the plurality of web services using the count of pending web service requests for each of the plurality of web services, and forwards the web service message to one of the plurality of web services to obtain data processing services for the application program.

These and various other features as well as advantages, which characterize the present invention, will be apparent from a reading of the following detailed description and a review of the associated drawings.

### BRIEF DESCRIPTION OF THE DRAWINGS

Referring now to the drawings in which like reference numbers represent corresponding parts throughout:

FIG. 1 illustrates system for providing web services for image processing in a document processing environment according to one embodiment of the present invention;

FIG. 2 illustrates a general purpose computing system for use in implementing as one or more computing embodiments of the present invention;

FIG. 3 illustrates a system for providing web services for image processing in a document processing environment that does not utilize load balancing processing for assignment of processing requests performed by the web services;

FIG. 4 illustrates a system for providing web services for image processing in a document processing environment that utilizes load balancing processing for assignment of processing requests performed by the web services according to an example embodiment of the present invention;

FIG. 5 illustrates a detailed system for providing web services for image processing in a document processing environment that utilizes load balancing processing for assignment of processing requests performed by the web services according to an example embodiment of the present invention;

FIG. 6 illustrates a set of processing modules implementing a load balancing web service according to one possible embodiment of the present invention; and

FIG. 7 illustrates flowchart implementing processing of a load balancing web service according to another embodiment of the present invention.

### DETAILED DESCRIPTION

This application relates in general to a method, apparatus, and article of manufacture for providing a web services for image processing in a document processing environment.

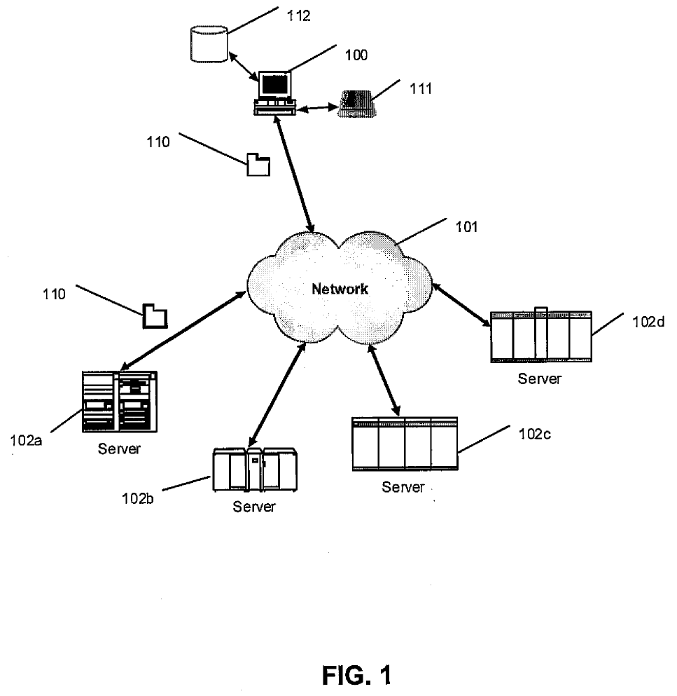

FIG. 1 illustrates a system for providing web services for image processing in a document processing environment according to one embodiment of the present invention. A document processing system 100 includes a document scanning device 111 and a data storage device 112 that is coupled to a communications network 101 to enable use of processing services provided by a plurality of servers 102a-102d that are also attached to the network 101. In this distributed processing environment, document processing system 100 generates scanned images of documents being processed. These images may be stored on the data storage device 112 or may be grouped into data files 110 that are transmitted to one or more of the plurality of servers 102a-102d for additional processing. These servers 102 generate processing results that are returned to document processing system 100 for use in subsequent processing and or further processing decisions.

In one possible embodiment, the document processing system 100 comprises a processing system for performing Check 21 processing, as required under 12 U.S.C. §§ 5001-5018, to process payment of financial checking documents. The document processing system 100 typically scans the checks to generate a data file 110 containing the scanned images. The data file 110 may utilize a standard file format such as the X9 standard format as defined by Accredited Standards Committee X9 Inc. (www.x9.org). Typically, document processing systems 100 consists of a programmable processing device of varying computational capacity that is used by end users. The system 100 may represent a small scanning device with an embedded processing system used by merchants to obtain payment for receipt of checks from customers. System 100 may also represent a larger check processing system used by banking institutions and similar vendors that process a large number of checks at a time.

One of ordinary skill in the art will readily recognize that the use of Check 21 processing and X9 files as disclosed herein represents just one of many possible distributed processing applications that use in conjunction with the present invention as recited within the attached claims. The use of this example embodiment is not intended to limit the scope of the present invention as it is intended to be merely illustrative of the operation of a processing system according to the present invention.

Because of this difference of data processing capabilities, document processing systems 100 may offload certain computationally intensive tasks, such as may be required in many image processing tasks, to other processing systems, such as remote servers attached to a common communications network, that are better able to quickly process these images. Depending upon the task being performed, the particular server being utilized for the particular task may be varied. As such, processing tasks may be more efficiently assigned and performed to obtain desired processing performance for end users. Additionally, as processing requirements of a system change, additional server resources may be made available to meet the increasing processing loads without impacting the end users. The example of FIG. 1 illustrates that the plurality of servers 102a-102d consists of different types of servers that may possess differing processing capabilities to permit the intelligent assignment of processing tasks to resources.

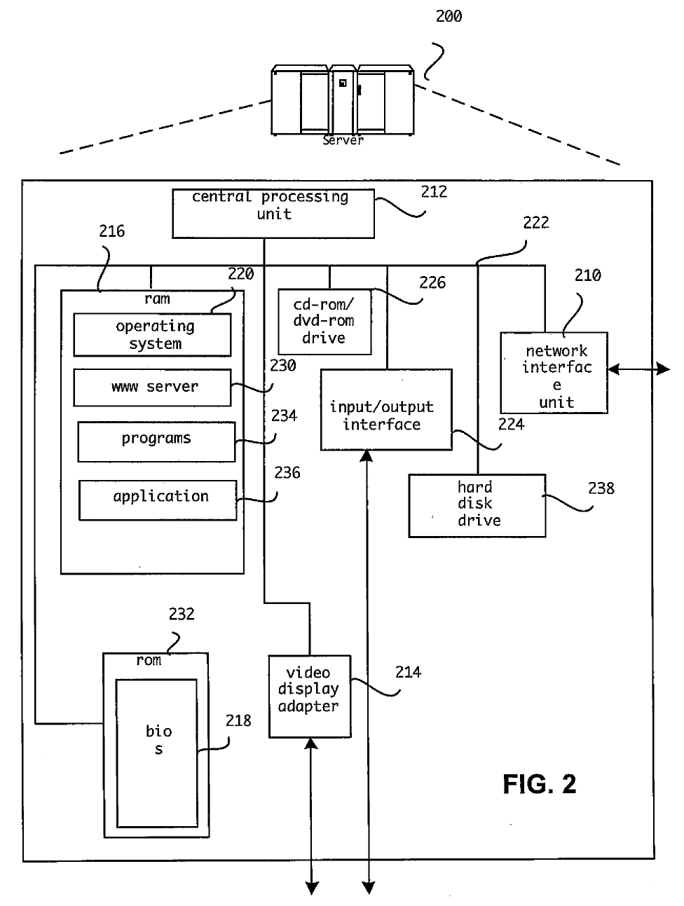

With reference to FIG. 2, an exemplary system for implementing the invention includes a general-purpose computing device in the form of a conventional personal computer, server or similar programmable processing system 200, including a processor unit 202, a system memory 204, and a system bus 206 that couples various system components including the system memory 204 to the processor unit 200. The system bus 206 may be any of several types of bus structures including a memory bus or memory controller, a peripheral bus and a local bus using any of a variety of bus architectures. The system memory includes read only memory (ROM) 208 and random access memory (RAM) 210. A basic input/output system 212 (BIOS), which contains basic routines that help transfer information between elements within the personal computer 200, is stored in ROM 208.

The personal computer 200 further includes a hard disk drive 212 for reading from and writing to a hard disk, a magnetic disk drive 214 for reading from or writing to a removable magnetic disk 216, and an optical disk drive 218 for reading from or writing to a removable optical disk 219 such as a CD ROM, DVD, or other optical media. The hard disk drive 212, magnetic disk drive 214, and optical disk drive 218 are connected to the system bus 206 by a hard disk drive interface 220, a magnetic disk drive interface 222, and an optical drive interface 224, respectively. The drives and their associated computer-readable media provide nonvolatile storage of computer readable instructions, data structures, programs, and other data for the personal computer 200.

Although the exemplary environment described herein employs a hard disk, a removable magnetic disk 216, and a removable optical disk 219, other types of computer-readable media capable of storing data can be used in the exemplary system. Examples of these other types of computer-readable mediums that can be used in the exemplary operating environment include magnetic cassettes, flash memory cards, digital video disks, Bernoulli cartridges, random access memories (RAMs), and read only memories (ROMs).

A number of program modules may be stored on the hard disk, magnetic disk 216, optical disk 219, ROM 208 or RAM 210, including an operating system 226, one or more application programs 228, other program modules 230, and program data 232. A user may enter commands and information into the personal computer 200 through input devices such as a keyboard 234 and mouse 236 or other pointing device. Examples of other input devices may include a microphone, joystick, game pad, satellite dish, and scanner. These and other input devices are often connected to the processing unit 202 through a serial port interface 240 that is coupled to the system bus 206. Nevertheless, these input devices also may be connected by other interfaces, such as a parallel port, game port, or a universal serial bus (USB). A monitor 242 or other type of display device is also connected to the system bus 206 via an interface, such as a video adapter 244. In addition to the monitor 242, personal computers typically include other peripheral output devices (not shown), such as speakers and printers.

The personal computer 200 may operate in a networked environment using logical connections to one or more remote computers, such as a remote computer 246. The remote computer 246 may be another personal computer, a server, a router, a network PC, a peer device or other common network node, and typically includes many or all of the elements described above relative to the personal computer 200. The network connections include a local area network (LAN) 248 and a wide area network (WAN) 250. Such networking environments are commonplace in offices, enterprise-wide computer networks, intranets, and the Internet.

When used in a LAN networking environment, the personal computer 200 is connected to the local network 248 through a network interface or adapter 252. When used in a WAN networking environment, the personal computer 200 typically includes a modem 254 or other means for establishing communications over the wide area network 250, such as the Internet. The modem 254, which may be internal or external, is connected to the system bus 206 via the serial port interface 240. In a networked environment, program modules depicted relative to the personal computer 200, or portions thereof may be stored in the remote memory storage device. It will be appreciated that the network connections shown are exemplary, and other means of establishing a communications link between the computers may be used.

Additionally, the embodiments described herein are implemented as logical operations performed by a computer. The logical operations of these various embodiments of the present invention are implemented (1) as a sequence of computer implemented steps or program modules running on a computing system and/or (2) as interconnected machine modules or hardware logic within the computing system. The implementation is a matter of choice dependent on the performance requirements of the computing system implementing the invention. Accordingly, the logical operations making up the embodiments of the invention described herein can be variously referred to as operations, steps, or modules.

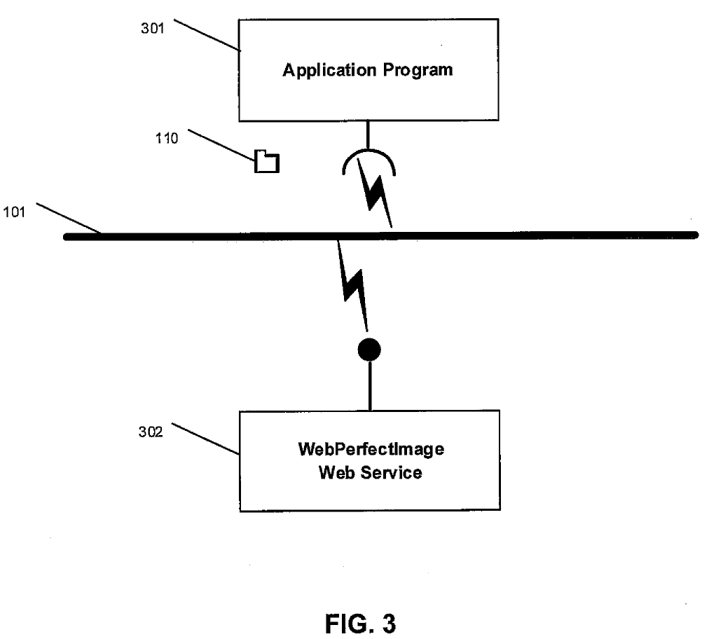

FIG. 3 illustrates a system for providing web services for image processing in a document processing environment that does not utilize load balancing processing for assignment of processing requests performed by the web services. In this example embodiment, application program 301 performs document processing tasks by communicating with WebPerfectImage Web Service 302 over communications network 101. Typically, application program 301 executes within document processing system 100 to process documents and generate data files 110. WebPerfectImage Web Service 302 typically executes on one of the plurality of servers 102a-102d.

Application program 301 communicates with Web Service 302 over the network 101 using a web service protocol such as ones created and defined using Simple Object Access Protocol (SOAP), Web Services Description language (WSDL), and Universal Description, Discovery and Integration (UDDI). Application program 301 uses these web service protocols to identify the available web services, understand the data interfaces, and initiate the web service processing. Application program 301 communicates directly with the web service application 302 on its hosting server 102. WebPerfectImage Web Service 302 performs image analysis functions, including image quality defect testing, courtesy amount recognition, image character recognition, magnetic ink character recognition (MICR), image usability analysis, and similar processing, on images passed to it in an X9 file 110. Web Service 302 returns data results and processed images to application program 301 when the processing is complete.

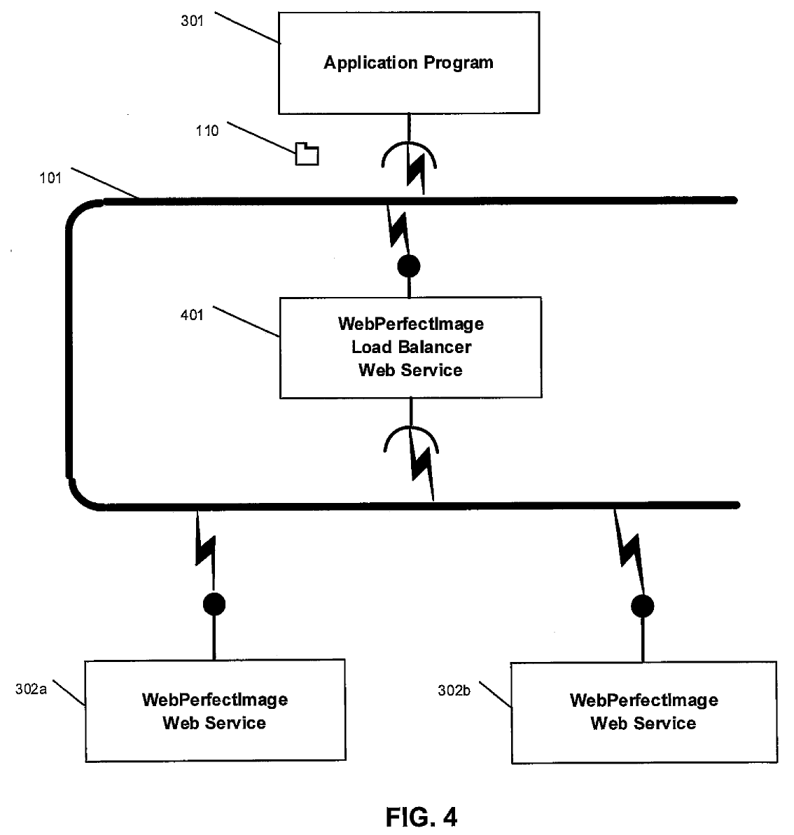

FIG. 4 illustrates a system for providing web services for image processing in a document processing environment that utilizes load balancing processing for assignment of processing requests performed by the web services according to an example embodiment of the present invention. In this embodiment, application program 301 seeks services from web services 302 over a network. In order to meet performance requirements, multiple instances of web service 302 are present on the network 101.

WebPerfectImage Load Balancer web service 401 provides scalability to WebPerfectImage web service 302 by serving as a distribution manager that performs network load balancing, thereby enabling multiple WebPerfectImage service instances 302a-302b running in parallel to appear as a single Image Analysis service instance. Application program 301 interacting with a single WebPerfectImage web service 302 instance will have an identical interface to WebPerfectImage Load Balancer web service 401 configured with multiple WebPerfectImage web service instances 302a-302b. Additional configuration and monitoring capabilities will be incrementally available for application use to manage the multiple WebPerfectImage web service instances 302a-302b configured to run as one WebPerfectImage web service 302.

Typically in larger configurations of WebPerfectImage Load Balancer web service 401, one instance of WebPerfectImage Load Balancer web service 401 runs multiple threads on a single server connected to multiple WebPerfectImage web service instances 302. These multiple WebPerfectImage web service instances 302 are then configured as single instances running multiple threads on additional servers and multiple servers will be configured to run as part of a single WebPerfectImage Load Balancer web service 401. In a small configuration, WebPerfectImage Load Balancer web service 401 may be run with WebPerfectImage web service 302 and other web services and applications on a single server with other WebPerfectImage web service instance 302 running on other servers. The mix of services 240 configured on one or more servers will be configured for optimal use of server resources based on current server technologies. The term server below is synonymous with service instance.

In order to configure WebPerfectImage Load Balancer web service 401, a Directory Service is utilized to manage the list of WebPerfectImage instances to be associated with an instance of WebPerfectImage Load Balancer web service 401. This association is enabled by defining a set of rules for how the Directory Service three tier hierarchy is constructed to facilitate understanding of the association. The three tiers of the Discovery Service hierarchy consist of Business Entities, Service Categories, and Service Entities Details) consistent with the UDDI web services specification. Within a Service Category the rules state that there will be one and only one WebPerfectImage Load Balancer web service instance 401. Any WebPerfectImage web service instance 302 within a Service Category are automatically associated with the WebPerfectImage Load Balancer web service instances 401. Multiple WebPerfectImage Load Balancer web service instance 401 are allowed by defining new Service Categories with a single WebPerfectImage Load Balancer web service instance 401 and one or more WebPerfectImage web service instances 302. Service Categories with WebPerfectImage web service instance 302 and no WebPerfectImage Load Balancer web service instance 401 are considered independent instances of WebPerfectImage web service 302 and not associated with a WebPerfectImage Load Balancer web service 401. There should always be one and only one instance of WebPerfectImage Load Balancer web service 401 defined within the Directory Service.

Additional associations are defined to determine the relationship of supporting services (Parameter, Results, Entitlement) to WebPerfectImage web service 302 services. Within a Service Category there will be one and only one of each of the following supporting services: Parameter, Entitlement, Results. Supporting Services may be used in other Service Categories to facilitate common use of supporting services.

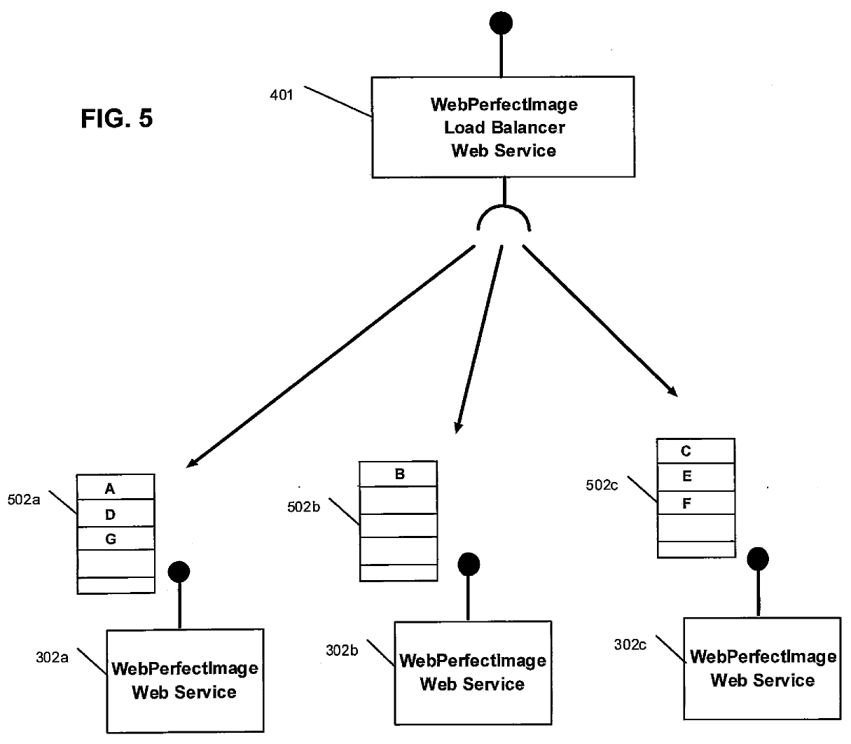

FIG. 5 illustrates a detailed system for providing web services for image processing in a document processing environment that utilizes load balancing processing for assignment of processing requests performed by the web services according to an example embodiment of the present invention. WebPerfectImage Load Balancer web service 401 receives a request from an application program 301 containing an X9 image file 110. These requests are forwarded to one of the plurality of web service servers 302a-303c for processing. These servers 302a-302c store the pending requests and corresponding X9 image files in respective request queues 502a-502c. These servers 302a-303c process pending requests in the order received, returning processing results to WebPerfectImage Load Balancer web service 401 which in turn returns the results to application program 301. Using this architecture, application program 301 interacts with the web services in the same manner illustrated in FIG. 3.

The load balancing process within the Load Balancing web service 401 is at the heart of present invention. WebPerfectImage Load Balancer web service 401 determines an identity of the next server that the request should be sent to 1) rotate the requests in round-robin fashion, 2) send requests to the server with the fewest current pending requests, and 3) prevent the number of currently pending requests from exceeding a predefined maximum number of simultaneous requests for a given server. WebPerfectImage Load Balancer web service 401 maintains a list of servers and a pointer to the current round robin selection. WebPerfectImage Load Balancer web service 401 maintains and updates information about each web service server 302a-303c including the number of currently pending requests and the maximum number of simultaneous requests permitted by each server.

For servers with Windows XP installed, the maximum is set to a value less than or equal to 10, whereas for servers with Windows Server 2003 install no limit is set. These maximum number of other computers that are permitted to simultaneously connect over the network is set to conform with Windows licensing requirements. For other operating systems running on the servers, a maximum limit may be set to provide a set throughput performance or other load related limit as desired by the operator of the server.

When an incoming request from an application program is received by the WebPerfectImage Load Balancer web service 401, the web service determines the least number of currently pending requests for every server that is currently accepting requests. A server is currently accepting requests if its number of currently pending requests does not exceed its maximum number of simultaneous requests. Assume that one or more servers are currently accepting requests. The possibility that no servers are currently accepting requests is addressed later.

Next, WebPerfectImage Load Balancer web service 401 finds the first server in the list, at or following the current round robin selection, that has the least number of currently pending requests, and return this server. If no servers are currently accepting requests return the current round robin selection. The code that executes the requests blocks execution until, for the selected server, the number of currently pending requests is less than the maximum number of simultaneous requests. Once a request has been serviced, WebPerfectImage Load Balancer web service 401 advances the round robin index to the next server in the list. Initially, the round robin selection is set to 0, and is advanced by setting (next round robin index)=(current round robin index+1) modulo (number of servers in the list).

The load balancing algorithm has provisions for a server to go offline and return online. When the maximum number of consecutive timed-out requests is exceeded for a particular server that server is marked offline and is no longer accepting requests. While the server is marked offline WebPerfectImage Load Balancer web service 401 attempts to contact the server. In the event that WebPerfectImage Load Balancer web service 401 succeeds in contacting the server the server is marked online and resumes accepting requests.

The load balancing process has provisions for dynamically adding and removing servers from the list. When a message to add a server is received the server is added to the list and begins accepting requests. When a message to remove a server is received the server is marked “removal of the server is pending” and stops accepting requests. When the number of currently pending requests reaches 0 the server is removed from the list.

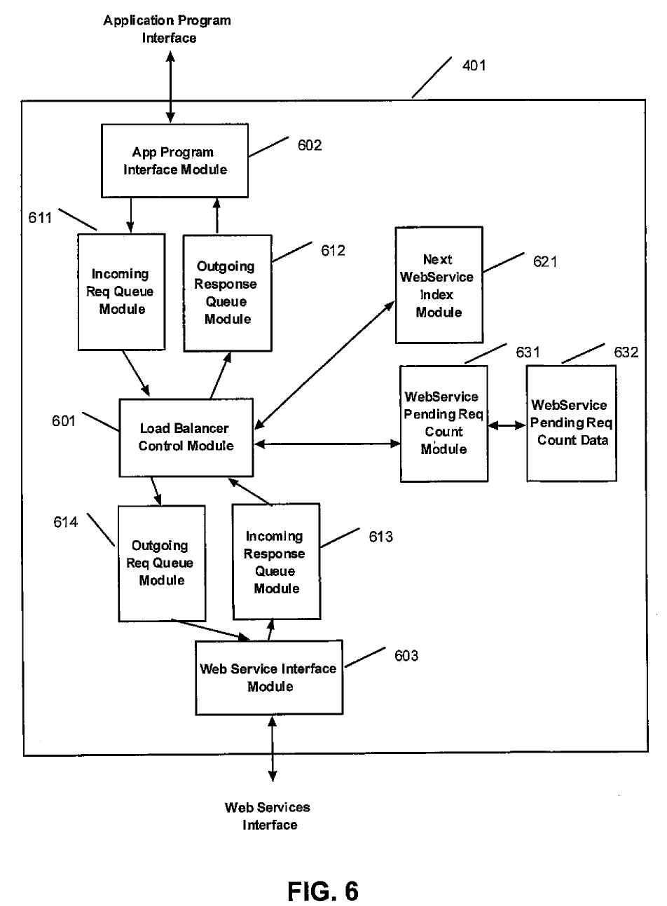

FIG. 6 illustrates a set of processing modules implementing a load balancing web service according to one possible embodiment of the present invention. WebPerfectImage Load Balancer web service 401 may consist of a load balancer control module 601, an application program interface module 602, and a web service interface module 603, WebPerfectImage Load Balancer web service 401 also consists of an incoming request queue module 611, an outgoing response queue module 612, an incoming response queue module 613, and an outgoing request queue module 614 to maintain various unprocessed messages during its operation. WebPerfectImage Load Balancer web service 401 also consists of a next web service ID index module 621, a web service pending request count module 631, and a web service pending request count data block 632.

Application program interface module 602 receives incoming web service request messages and corresponding X9 files 110 that are stored within incoming request queue module 611 until they can be process by load balancer control module 601. Load balancer control module 601 uses Next web service ID index module 621 and web service pending request count module 631 to determine the identity of the web service to receive the incoming request. Load balancer control module 601 sends the request and corresponding X9 file to the appropriate web service through the outgoing request queue module 614 and the Web service interface module 603. Load balancer control module 601 also updates the number of pending requests for the appropriate web server using Web service pending request count module 631, Web service pending request count module 631 stores the current count of pending requests for each server within Web service pending request count data block 632.

Web service interface module 603 receives responses to the processing requests and stores the responses within incoming response queue module 613. Load balancer control module 601 processes these responses from the incoming response queue module 613 in the order received and sends the response to the requesting application program 301 the outgoing response queue module 612 and application program interface module 602 respectively. Load balancer control module 601 also updates the count of pending requests for a server using Web service pending request count module 631 to indicate the completion of the processing request.

While the above arrangement of processing modules provides the functionality of the load balancing web service 401, one of ordinary skill in the art will readily recognize that other possible organization of processing modules may be used to implement such a web service without deviating from the spirit and scope of the present invention and recited within the attached claims.

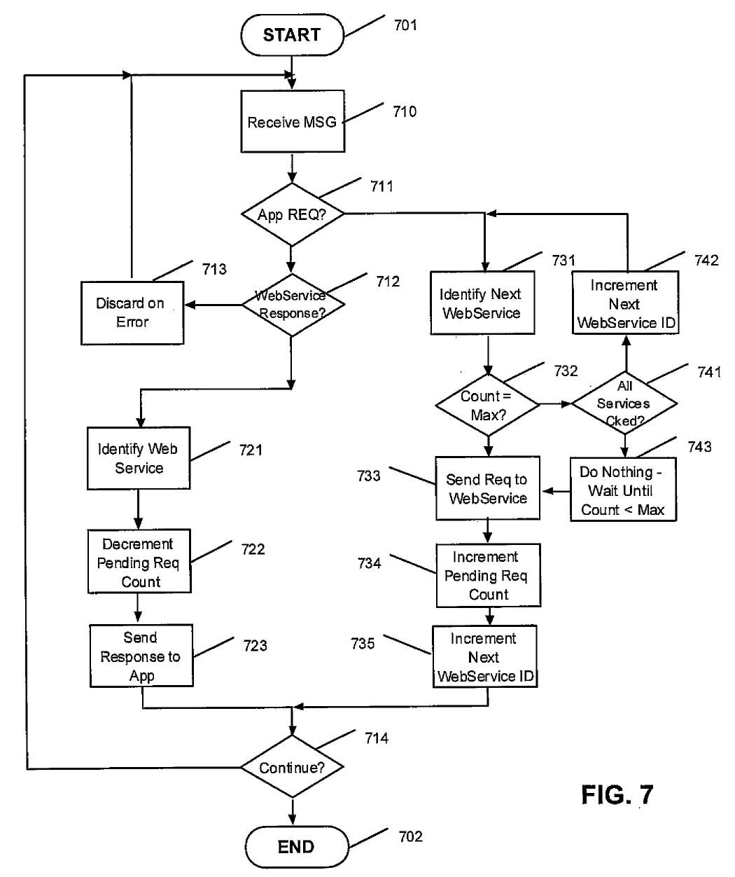

FIG. 7 illustrates a flowchart implementing processing of a load balancing web service according to another embodiment of the present invention. The processing starts 701 when a web service message is received by module 710. These web services messages may include an application web service processing request message and corresponding X9 file 110 from application program 301 and web service response message from one of the plurality of web service servers 302a-302c. If the received message corresponds to an application web service processing request message, test module 711 transfers processing to module 731 to begin processing of the application web service processing request message. If the incoming message corresponds to a web service response message, test module 712 transfers processing to module 721 to process the response message. If neither of these types of message is received, the message is discarded by module 713 before processing returns to module 710 to process the next message received by the load balancing web service 401.

When the received message corresponds to an application web service processing request message, module 731 identifies the next web service server 302a-302c to be utilized to process the application web service processing request message using the round robin arrangement described above. Test module 732 determines if this particular web service is able to receive an additional pending request based upon the maximum number of pending requests supported by the server. If an additional request may be sent to the server, module 733 sends the request to the web service server. Module 734 increments the count of pending requests for this web service server and module 735 increments the web service index modulo the number of servers and stores the index in the web service pending request count data 632. Test module 714 controls the overall operation of the processing to determine if the processing is to continue by returning the processing to module 710 to begin the processing for the next message.

If the test module 732 find that the server identified by the next web service index has a maximum number of pending requests and thus cannot receive an additional request, test module 741 determines if all web service servers have been checked. If additional web service servers may be checked, processing proceeds to module 742 to increment the web service index before repeating the processing of module 731. This processing loop continues until either a server is identified and the request is processed by module 733 as discussed above or test module 741 determines that all web service servers have been checked and are all prevented from receiving an additional request. If this latter condition is identified, test module 741 passing the processing to module 743 in which nothing occurs until a request has been processed and a corresponding response from a web service server is processed.

When the incoming message corresponds to a web service response message, module 721 identifies the web service server that generated the response message. Module 722 decrements the count of pending requests to indicate the completion of this particular request. This count is stored within the web service request count data 632 as discussed above. Module 723 forwards the response message to the appropriate application program 301 to complete the processing of the request. Processing then returns to process a next message using module 710. The overall processing continues until the load balancing web service 401 terminates operation when test module 714 ends the operation and the web service ends 702.

While the above embodiments of the present invention describe a system and method for providing web services for image processing in a document processing environment, one skilled in the are will recognize that the use of web services with load balancing as claimed herein may also be used in other web based distributed processing systems without deviating from the spirit and scope of the present invention. As long as the web services are provided with a load balancing web service, the present invention to would be useable in other processing applications. It is to be understood that other embodiments may be utilized and operational changes may be made without departing from the scope of the present invention.

The foregoing description of the exemplary embodiments of the invention has been presented for the purposes of illustration and description. They are not intended to be exhaustive or to limit the invention to the precise forms disclosed. Many modifications and variations are possible in light of the above teaching. It is intended that the scope of the invention be limited not with this detailed description, but rather by the claims appended hereto. Thus the present invention is presently embodied as a method, apparatus, computer storage medium or propagated signal containing a computer program for providing a method, apparatus, and article of manufacture providing web services for image processing in a document processing environment.

What is claimed is:

1. A method for providing web services for image processing in a document processing environment, the method comprising:
receiving a web service request message from an application program;
maintaining a count of pending web service requests for each of a plurality of web services providing data processing services to the application program;
selecting one of the plurality of web services using the count of pending web service requests for each of the plurality of web services; and
forwarding the web service message to one of the plurality of web services to obtain data processing services for the application program.

2. The method according to claim 1, wherein the method further comprises:
receiving a web service message from the application program; and
identifying the web service message as the web service request message.

3. The method according to claim 2, wherein the method further comprises:
upon receiving the web service message, determining if the web service message corresponds to a web service response message; and
if the web service message is a web service response message:
identify the web service responding;
decrement the count of web service responses for the web service; and
forward the web service response message to the application program.

4. The method according to claim 2, wherein the selecting one of the plurality of web services utilizes a round robin selection mechanism.

5. The method according to claim 4, wherein the round robin selection mechanism maintains a next web service ID count for identifying one of the plurality of web services to be selected.

6. The method according to claim 5, wherein the web service ID count is incremented modulo an active number of web services count each time a web service is selected to accept a forwarding of a web service request message.

7. The method according to claim 6, wherein the active number of web services count corresponds to a number of active web services within the distributed system available for use in processing web service request messages.

8. The method according to claim 1, wherein the web service corresponds to a web perfect image processing service that performs image analysis functions on images received within webs service request messages and that returns web service response messages containing data results from processing performed by the web service and processed images.

9. The method according to claim 8, wherein the image analysis functions comprises:
image quality defect testing processing;
courtesy amount recognition processing;
image character recognition processing;
magnetic ink character recognition processing; and image usability analysis processing.

10. A computer-readable storage medium containing encoded data corresponding to computer readable instructions for a programmable computer system for implementing a method for providing web services for image processing in a document processing environment, the method comprising:
receiving a web service message from an application program; and
identifying the web service message as a web service request message;
maintaining a count of pending web service requests for each of a plurality of web services providing data processing services to the application program;
selecting one of the plurality of web services using the count of pending web service requests for each of the plurality of web services utilizing a round robin selection mechanism; and
forwarding the web service message to one of the plurality of web services to obtain data processing services for the application program;
wherein the round robin selection mechanism maintains a next web service ID count for identifying one of the plurality of web services to be selected.

11. The computer-readable storage medium according to claim 10, wherein the method further comprises:
upon receiving the web service message, determining if the web service message corresponds to a web service response message; and
if the web service message is a web service response message:
identify the web service responding;
decrement the count of web service responses for the web service; and
forward the web service response message to the application program.

12. The computer-readable storage medium according to claim 10, wherein the web service ID count is incremented modulo an active number of web services count each time a web service is selected to accept a forwarding of a web service request message; and
the active number of web services count corresponds to a number of active web services within the distributed system available for use in processing web service request messages.

13. The computer-readable storage medium according to claim 10, wherein the web service corresponds to a web perfect image processing service that performs image analysis functions on images received within webs service request messages and that returns web service response messages containing data results from processing performed by the web service and processed images.

14. The computer-readable storage medium according to claim 13, wherein the image analysis functions comprises:
image quality defect testing processing;
courtesy amount recognition processing;
image character recognition processing;
magnetic ink character recognition processing; and
image usability analysis processing.

15. A distributed processing system for providing image processing in a document processing environment; the system comprising:
an application program;
a load balancing web service; and
a plurality of web services providing data processing services to the application program;
wherein the load balancing web service:
receives a web service request message from the application program;
maintains a count of pending web service requests for each of a plurality of web services providing data processing services to the application program;
selects one of the plurality of web services using the count of pending web service requests for each of the plurality of web services; and
forwards the web service message to one of the plurality of web services to obtain data processing services for the application program.

16. The distributed processing system according to claim 15, wherein the plurality of web services corresponds to a web perfect image processing service that performs image analysis functions on images received within webs service request messages and that returns web service response messages containing data results from processing performed by the web service and processed images.

17. The distributed processing system according to claim 16, wherein the image analysis functions comprises:
image quality defect testing processing;
courtesy amount recognition processing;
image character recognition processing;
magnetic ink character recognition processing; and
image usability analysis processing.
